(19) United States
(12) Patent Application Publication
(10) Pub. No.: US 2005/0030917 A1
(43) Pub. Date: Feb. 10, 2005

(54) Device, system, method and computer readable medium obtaining a network attribute, such as a DNS address, for a short distance wireless network

(76) Inventors: Amit Haller, Belmont, CA (US); Peter Fornell, Oswego, OR (US); Avraham Itzachak, Ra'anana (IL); Ziv Haparnas, Tel Aviv (IL); Yosi Levi, Kefar Aviv (IL); Eduard Kvetny, Rishon Letzion (IL); Amir Glick, Tel Aviv (IL); Vladimir Holostov, Kfar Saba (IL); Alon Cohen, Ntzaney-Oz (IL)

Correspondence Address: VIERRA MAGEN MARCUS HARMON & DENIRO LLP, 685 MARKET STREET, SUITE 540, SAN FRANCISCO, CA, 94105, US

(21) Appl. No.: 10/809,663

(22) Filed: Mar. 25, 2004

Related U.S. Application Data
(63) Continuation-in-part of application No. 10/666,776, filed on Sep. 18, 2003.
Application No. 10/666,776 is a continuation-in-part of application No. 10/619,857, filed on Jul. 14, 2003.
Application No. 10/619,857 is a continuation-in-part of application No. 10/435,098, filed on May 9, 2003.
Application No. 10/435,098 is a continuation-in-part of application No. 09/932,180, filed on Aug. 17, 2001.

(51) Int. Cl. H04Q 7/00

(52) U.S. Cl. 370/328; 370/338; 370/400; 370/351

(57) ABSTRACT

A device, method, system and computer readable medium allows for selectively obtaining a cellular network attribute, such as a DNS address. In an embodiment of the present invention, a device, such as a cellular telephone, includes a processor and memory capable to store a software component for selectively obtaining a cellular network attribute from a cellular network responsive to a first terminal in a short distance wireless network communicating with the device. In an embodiment of the present invention, the cellular network is a Global System for Mobile communications (“GSM”) cellular network and the DNS address is obtained using cellular data service, such as a general packet radio service (“GPRS”)

### RELATED APPLICATION

This application is continuation-in-part of U.S. patent application Ser. No. 10/666,776, entitled “A Device, System, Method And Computer Readable Medium For Attaching To A Device Identified By An Access Point Name In A Wide Area Network Providing Particular Services” filed on Sep. 18, 2003, which application is a continuation-in-part of U.S. patent application Ser. No. 10/619,857, entitled “A Device, System, Method And Computer Readable Medium For Selectively Attaching To A Cellular Data Service” filed on Jul. 14, 2003, which application is a continuation-in-part of U.S. patent application Ser. No. 10/435,098, entitled “Device, System, Method And Computer Readable Medium For Fast Recovery Of IP Address Change” filed on May 9, 2003, which application is a continuation-in-part of 09/932,180, entitled “A System, Device and Computer Readable Medium for Providing Networking Services on a Mobile Device” filed on Aug. 17, 2001, which applications are incorporated herein by reference.

### FIELD OF THE INVENTION

This invention relates generally to networks.

### BACKGROUND

In a short distance wireless network, a terminal or device may need to access a Wide Area Network (“WAN”) in order to obtain a service or data. A cellular network, such as a Global System for Mobile Communications (“GSM”) network or Universal Mobile Telecommunications System (“third-generation (3G)”) network, may be included in the WAN and provides services to cellular devices, such as a cellular telephone. For example, a cellular telephone may need access to a cellular data service and a GSM network provides a General Packet Radio Service (“GPRS”) in order to provide that service. A GSM network may also include a Domain Naming Service (“DNS”) in order to provide network addresses to devices in the WAN.

However, devices in the WAN may not have the current network attributes, such as the current DNS address. For example, a device or terminal may have a previous or “stale” DNS address. The current DNS address could be different than the previous DNS address stored in the device and/or terminal because 1) a telecommunication operator changes a WAN configuration, 2) a user has moved into new WAN coverage that does not allow the previous DNS address, 3) the WAN load balances DNS services and thus provides different DNS addresses each session, 4) a user changes a Subscriber Identity Module (“SIM”) card in a device, 5) a user changes a WAN configuration, 5) a user switches to a different telecommunication provider that has a different WAN and/or Access Point Name (“APN”) which provides network services.

Therefore, it is desirable to provide a device, system, method and computer readable medium obtaining a network attribute, such as a DNS address, for a short distance wireless network.

### SUMMARY

A device, method, system and computer readable medium allows for selectively obtaining a cellular network attribute, such as a DNS address to a DNS. In an embodiment of the present invention, a device, such as a cellular telephone, includes a processor and memory capable to store a software component for selectively obtaining a cellular network attribute from a cellular network responsive to a first terminal in a short distance wireless network communicating with the device.

In another embodiment of the present invention, the communicating includes the first terminal establishing a short-range LAN access profile session with the device.

In an embodiment of the present invention, the software component establishes a cellular data service session, and obtains a DNS address using the cellular data service session.

In an embodiment of the present invention, the software component establishes a cellular data service session responsive to a comparison of a current public Internet Protocol (“IP”) address and current APN and a previous public IP address and a previous APN.

In an embodiment of the present invention, the software component establishes a cellular data service session and obtains a DNS address in the cellular network responsive to a threshold time value.

In an embodiment of the present invention, the software provides a first DNS address, stored in the device, to the first terminal and obtains a second DNS address in the cellular network using a cellular data service session and provides the second DNS address to the first terminal.

In an embodiment of the present invention, the software provides a previous DNS address to the first terminal and terminates a connection with the first terminal responsive to a comparison of the previous DNS address and a current DNS address obtained from the cellular network using a cellular data service session.

In an embodiment of the present invention, the network attribute is obtained using a GPRS in a GSM cellular network.

In a method embodiment of the present invention, a short-range radio message, requesting a DNS address, is generated by a terminal in a short distance wireless network. A device in the short distance wireless network receives the short-range radio message and generates a cellular signal to obtain a cellular data service in a cellular network. The device obtains a DNS address in the cellular network and generates a short-range radio message, including the DNS address, to the terminal.

In an embodiment of the present invention, a system for providing communication between a cellular network and a short distance wireless network comprises a hand-held wireless device and a first wireless device to generate a short-range radio message. The hand-held wireless device includes 1) a cellular transceiver to communicate with the cellular network, including to receive a DNS address from a cellular data service; 2) a short-range transceiver to communicate with the short distance wireless network, including to receive a short-range radio message; and 3) a memory, coupled to the cellular and short-range transceivers, capable to store a software component for obtaining the DNS address responsive to receiving the short-range radio message.

In an embodiment of the present invention, an article of manufacture, including a computer readable medium comprises a short-range radio software component to receive a first short-range radio signal in a short distance wireless network. A cellular software component provides a communication signal in a cellular network. A DNS software component obtains a DNS address in a cellular network responsive to receiving the first short-range radio signal, wherein the short-range radio software component generates a second short range radio signal including the DNS address.

Other aspects and advantages of the present invention can be seen upon review of the figures, the detailed description, and the claims that follow.

### BRIEF DESCRIPTION OF THE FIGURES

FIG. 1 illustrates a system according to an embodiment of the present invention.

FIG. 2 illustrates thin terminals and a wireless device according to an embodiment of the present invention.

FIGS. 3a-b are hardware block diagrams of a wireless device and a wireless hand-held device according to an embodiment of the present invention.

FIGS. 4-6 are software block diagrams for a wireless device according to an embodiment of the present invention.

FIG. 7a is a software block diagram of manager software in manager server 102 illustrated in FIG. 1 according to an embodiment of the present invention.

FIG. 7b illustrates a DNS server and DNS sever software according to an embodiment of the present invention.

FIGS. 8a-8f are flowcharts of methods according to embodiments of the present invention.

### DETAILED DESCRIPTION

I. System Overview

The following description and claims relate to a device, method, system, and computer readable medium for obtaining a network attribute, such as a DNS address to a DNS, from a WAN, for a short distance wireless network, and in particular for terminals in the short distance wireless network.

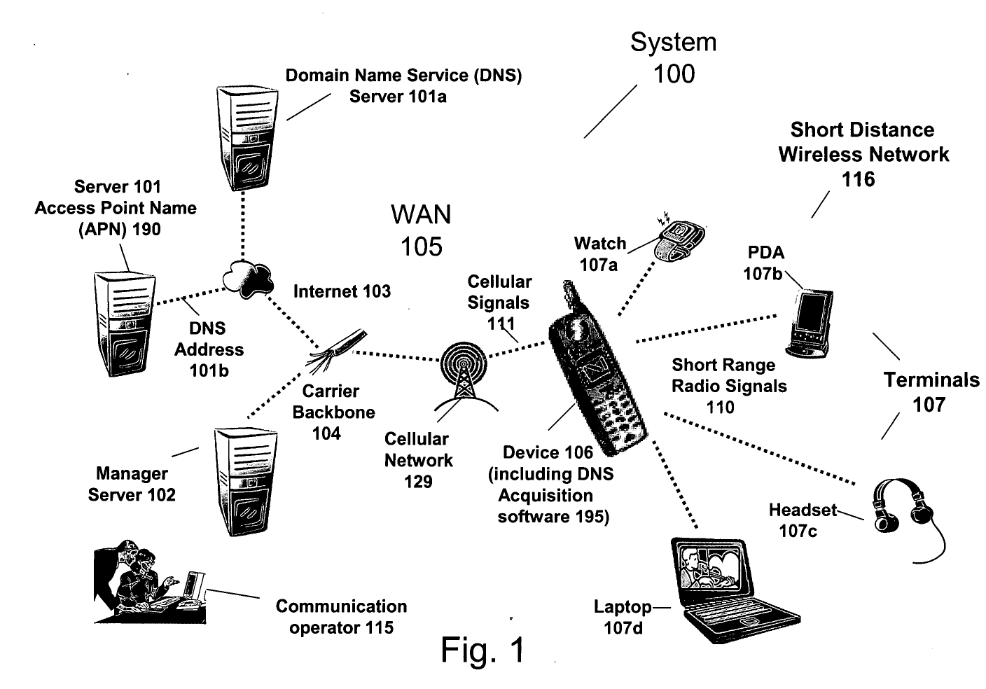

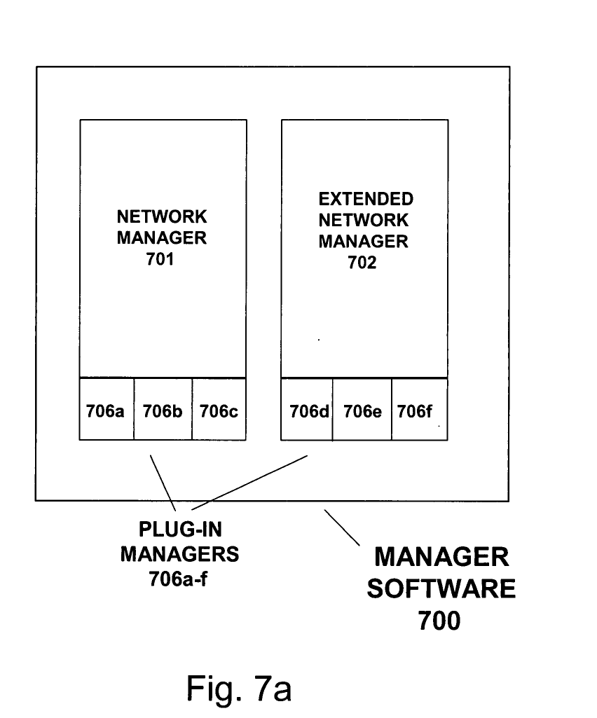

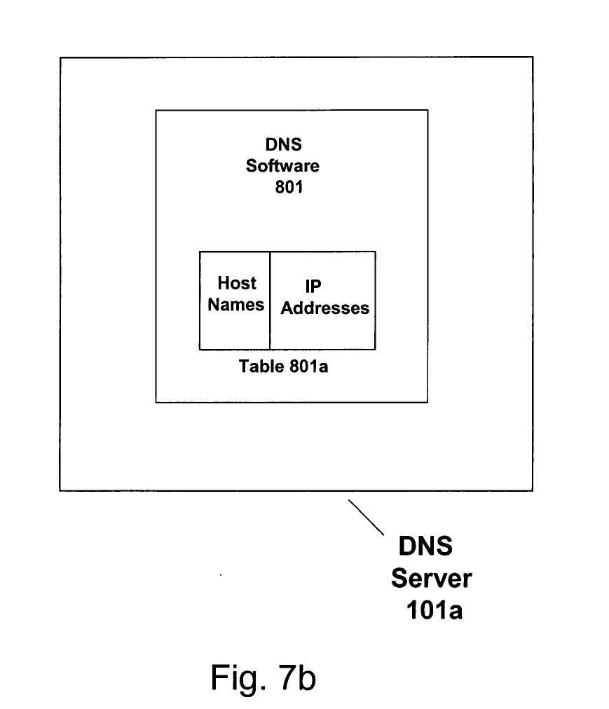

A DNS address identifies a location in a WAN for accessing a service, in particular a DNS, for translating host names or domain names into IP addresses. In an embodiment of the present invention, a DNS address 101b identifies a service provided by DNS software component 801 stored on a processing device or DNS server 101a as shown in FIGS. 1 and 7b. In alternate embodiments of the present invention, DNS software component 801 is distributed among multiple processing devices. In an alternate embodiment of the present invention, a DNS software component 801 is stored and accessed from server 101.

A DNS address 101b is provided at an APN 190 (or server 101) in WAN 105 in an embodiment of the present invention. In an embodiment of the present invention, a device 106 includes a DNS Acquisition (“Acq”) software component 195 that obtains a DNS address 101b from WAN 105 for terminals 107 in short distance wireless network 116 as shown in FIG. 1.

In an embodiment of the present invention, an APN is a particular address or IP domain having predetermined privileges that may be accessed or used by devices in a WAN. For example an APN may identify a location for a General Packet Radio Service (“GPRS”) in a GSM network. An APN may also identify a location for a Wireless Access Protocol (“WAP”) service, Hypertext Translation Protocol (“HTTP”) service, messaging service or Internet access.

In an embodiment of the present invention, a short distance wireless network is a network of processing devices, such as a personal computer or headset, that span a relatively small physical area, wherein at least one device generates and receives a short-range radio signal for communicating with another device in the network. In an embodiment of the present invention, a short-range radio signal can travel between approximately 0 and approximately 1000 feet. An example of a short distance wireless network includes a network of devices formed by Bluetooth™, HomeRF, 802.11 technologies, or an equivalent, singly or in combination. In an embodiment of the present invention, each processing device in a short distance wireless network has its own processing unit that executes a software component stored on the processing device memory, but also may access data and devices on the short distance wireless network. In an embodiment of the present invention, a wire, and in particular an Ethernet, provides communication between two or more processing devices in a short distance wireless network. In an alternate embodiment, electromagnetic signals provide wireless communication between one or more processing devices in a short distance wireless network. In still another embodiment, both wires and electromagnetic signals provide communication between processing devices in a short distance wireless network.

In an embodiment of the present invention, a WAN includes multiple local area networks (“LANs”) and/or short distance wireless networks connected over a relatively large distance. Telephone lines and electromagnetic signals, singly or in combination, couple the LANs and/or short distance wireless networks in a WAN. In an embodiment of the present invention, WAN 105 includes a cellular network 129 generating and receiving cellular signals 111. In an embodiment of the present invention, cellular network 129 includes multiple APNs identifying respective IP domains or services provided by a single or multiple processing devices in WAN 105. In an embodiment of the present invention, a cellular network is defined as a communication system dividing a geographic region into sections, called cells. In an analog embodiment of the present invention, the purpose of this division is to make the most use out of a limited number of transmission frequencies. In an analog embodiment of the present invention, each connection, or for example conversation, requires its own dedicated frequency, and the total number of available frequencies is about 1,000. To support more than 1,000 simultaneous conversations, cellular systems allocate a set number of frequencies for each cell. Two cells can use the same frequency for different conversations so long as the cells are not adjacent to each other.

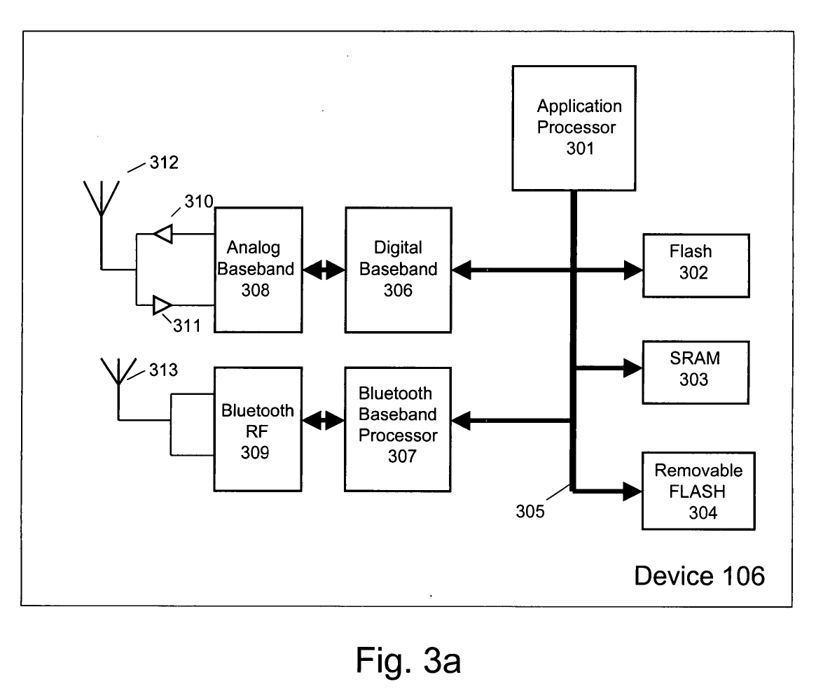

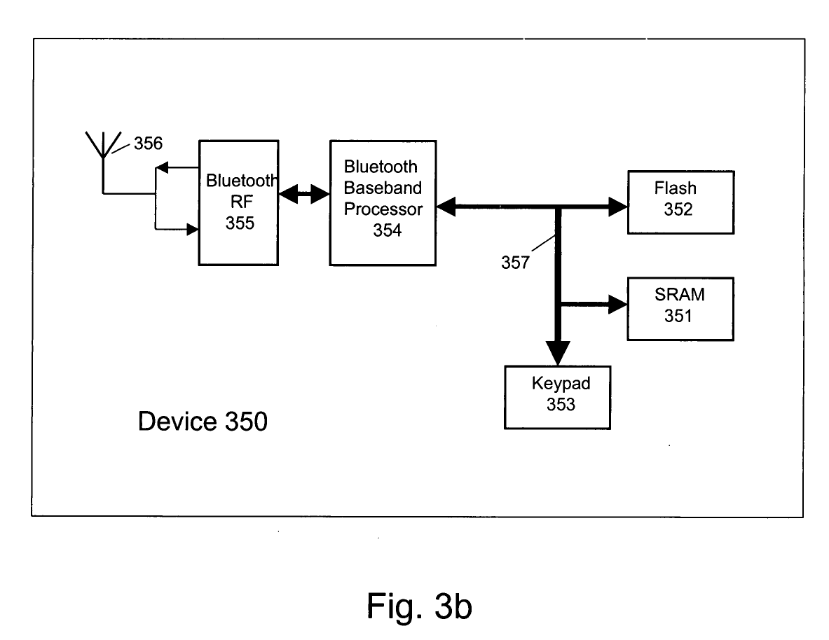

FIG. 1 illustrates system 100 according to an embodiment of the present invention. System 100 includes other devices or terminals 107 coupled to wireless device 106. In an embodiment of the present invention, device 106 and one or more terminals 107 communicate to form a short distance wireless network 116. In an embodiment of the present invention, terminals 107 are coupled to device 106 by short-range radio signals 110 to form short distance wireless network 116. In an embodiment of the present invention, some or all of terminals 107 may have wired connections. In an embodiment of the present invention, terminals 107 include a watch 107a, PDA 107b, headset 107c and laptop computer 107d that generate respective output signals. In an alternate embodiment, fewer or more terminals are used in short distance wireless network 116. In an alternate embodiment, terminals 107 include a desktop computer, a pager, a pen, a printer, a watch, game console, a thin terminal, a messaging terminal, a digital camera or an equivalent. In an embodiment of the present invention, terminals 107 include a Bluetooth™ 2.4 GHz transceiver. Likewise, device 106 includes a Bluetooth™ 2.4 GHZ transceiver. In an alternate embodiment of the present invention, a Bluetooth™ 5.7 GHZ transceiver is used. Hardware for device 106 and terminals 107 are illustrated in FIGS. 3a-b in an embodiment of the present invention.

In alternate embodiments of the present invention, other local wireless technologies, such as 802.11 or HomeRF signals, are used to communicate between device 106 and terminals 107.

In an embodiment of the present invention, WAN 105 is coupled to device 106. In an embodiment of the present invention, WAN 105 includes a cellular network 129 transmitting and receiving cellular signals 111. In an embodiment of the present invention, cellular signals 111 are transmitted using a protocol, such as a GSM protocol with a GPRS. In alternate embodiments, a Code Division Multiple Access (“CDMA”), CDMA 2000, Universal Mobile Telecommunications System (“UMTS”), Time Division Multiple Access (“TDMA”), or 3G protocols or an equivalent is used.

In an embodiment of the present invention, WAN 105 includes carrier backbone 104, servers 101a, 101 and 102, and Internet 103. In an embodiment of the present invention, IP packets are transferred between the components illustrated in FIG. 1. In alternate embodiments of the present invention, other packet types are transferred between the components illustrated in FIG. 1. In an embodiment of the present invention, a packet includes predetermined fields of information, such as header field and data field. A header field may include information necessary in transferring the packet, such as a source IP address. In an embodiment of the present invention, short-range radio signals 110 from a terminal in short distance wireless network 116 include an IP address and port number identifying a requested service at a particular APN.

In an embodiment of the present invention, WAN 105 includes an IP public or private network, such as a corporate secured network using a Virtual Private Network (“VPN”).

In an alternate embodiment of the present invention, device 106 is coupled to WAN 105 by an Ethernet, Digital Subscriber Line (“DSL”), or cable modem connection, singly or in combination.

In an embodiment of the present invention, device 106 is a cellular handset or telephone. In an alternate embodiment of the present invention, device 106 is a cellular enabled PDA, wireless modem and/or wireless laptop computer.

In an embodiment of the present invention, WAN 105 is coupled to a wireless carrier internal network or carrier backbone 104. In an embodiment of the present invention, server 102 is coupled to carrier backbone 104. In an alternate embodiment of the present invention, carrier backbone 104 is coupled to Internet 103. Server 101 and 101a is coupled to Internet 103. In an embodiment of the present invention, servers 101 and 102 provide information, such as web pages or application software components, to terminals 107 by way of device 106. In an embodiment of the present invention, DNS server 101a executing instructions of DNS software component 801 provides a DNS to device 106. In an embodiment of the present invention, manager server 102 provides a microrouter 404 and/or network service plug-ins 406a-l to device 106, as described below. Further, manager server 102, monitors applications and terminals in a short distance wireless network 116. In an embodiment of the present invention, terminals 107 share services and communicate by way of device 106.

In an embodiment of the present invention, one or more terminals in short distance wireless network 116 accesses information and/or services from server 101 and/or 101a. In an embodiment of the present invention, server 101 executes service software identified by APN 190, and in particular proves a DNS address 101b for DNS server 101a or DNS software component 801 executing on server 101a. In an embodiment of the present invention, servers 101 and 101a provide device 106 with public IP addresses, respectively, to allow for devices in short distance wireless network 116 to communicate, by way of a Transmission Control Protocol/Internet Protocol (“TCP/IP”) protocol connection, with servers 101 and 101a. In an alternate embodiment, servers 101 or 101a are a termination point for a session initiated by device 106 (or terminals 107) and an alternate address server provides public IP address to device 106.

II. Hand-Held Device/Terminal Hardware

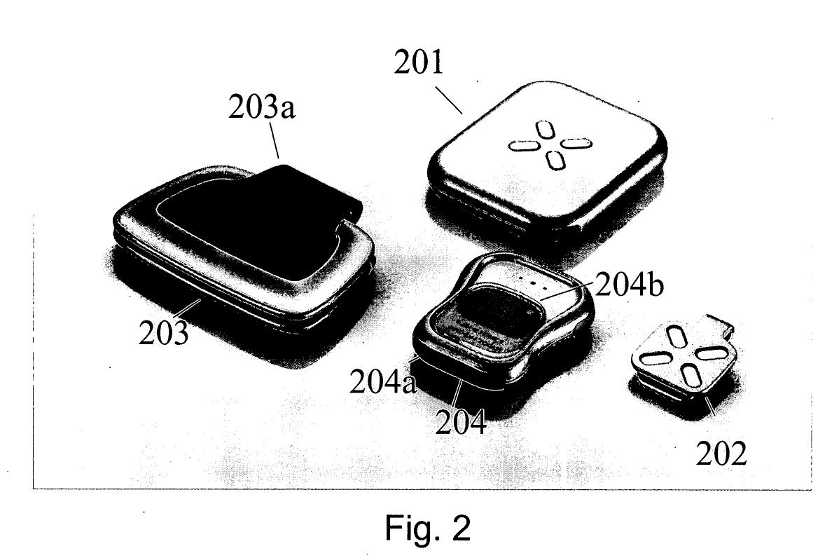

FIG. 2 illustrates embodiments of terminals 107 and device 106. In an embodiment of the present invention, there are two types of terminals: 1) smart terminals and 2) thin terminals. In an alternate embodiment of the present invention, smart terminals execute user logic and applications. Smart terminals have a relatively powerful processing unit, operating system and applications. Their main needs from a short distance wireless network 116 are access to a WAN 105 through TCP/IP and other network services such as storage and execution. For example, a laptop computer 107d and PDA 107b are smart terminals. Thin terminals have a relatively low power processing unit and operating system. They are mainly used as peripherals to an application server in a short distance wireless network 116 and their main task is user interaction, rendering output for a user and providing an application server with a user's input. For example, a watch 107a or messaging terminals can be thin terminals.

FIG. 2 illustrates thin terminals. Voice terminal 204 includes a display 204b and a retractable keypad 204a. Messaging Terminal 203 is illustrated in a closed position with a hinge 203a used to open and close terminal 203. Terminal 203 also includes a miniature QWERTY keyboard and display when opened.

In an embodiment of the present invention, device 201 is a cellular modem and includes a clip 202 for a belt.

FIG. 3a illustrates a hardware block diagram of device 106 in an embodiment of the present invention. Device 106 includes both internal and removable memory. In particular, device 106 includes internal FLASH (or Electrically Erasable Programmable Read-Only Memory (“EEPROM”) and Static Random Access Memory (“SRAM”) 302 and 303, respectively. Removable FLASH memory 304 is also used in an embodiment of the present invention. Memories 302, 303, and 304 are coupled to bus 305. In an embodiment of the present invention, bus 305 is an address and data bus. Application processor 301 is likewise coupled to bus 305. In an embodiment of the present invention, processor 301 is a 32-bit processor.

Bluetooth™ processor 307 is also coupled to bus 305. Bluetooth™ RF circuit 309 is coupled to Bluetooth™ processor 307 and antenna 313. Processor 307, RF circuit 309 and antenna 313 transmit and receive short-range radio signals to and from terminals 107, illustrated in FIG. 1, or device 350, illustrated in FIG. 3b.

Cellular, such as GSM, signals are transmitted and received using digital circuit 306, analog circuit 308, transmitter 310, receiver 311 and antenna 312. Digital circuit 306 is coupled to bus 305. In alternate embodiments, device 106 includes a display, a speaker, a microphone, a keypad and a touchscreen, singly or in combination.

In a preferred embodiment of the present invention, device 106 has a dual bus architecture where a first processor is coupled to a cellular transceiver by a first bus and a second processor is coupled to a short-range transceiver by a second bus. In an embodiment, a third bus couples the first and second processors.

FIG. 3b illustrates device 350 that is a hand-held device in an embodiment of the present invention. Device 350, in an embodiment of the present invention, is one of the terminals 107 illustrated in FIG. 1. Similar to device 106, device 350 includes SRAM and FLASH memory 351 and 352, respectively. Memories 351 and 352 are coupled to bus 357. In an embodiment of the present invention, bus 357 is an address and data bus. Keypad 353 is also coupled to bus 357. Short-range radio signals are transmitted and received using Bluetooth™ processor 354 and Bluetooth™ RF circuit 355. Antenna 356 is coupled to Bluetooth™ RF circuit 355. In an embodiment of the present invention, antenna 356 transmits and receives short-range radio signals. In alternate embodiments, device 350 includes a display, a speaker, a microphone, a keypad and a touchscreen, singly or in combination. As one of ordinary skill in the art would appreciate, other hardware components would be provided for device 350 in alternate embodiments of the present invention. For example in an embodiment in which device 350 is a laptop computer 107d, a disk drive and other input/output components are present.

In a preferred embodiment of the present invention, device 350 likewise has a dual bus architecture where a first processor is a first bus and a second processor is coupled to a short-range transceiver by a second bus. In an embodiment, a third bus couples the first and second processors.

III. Software

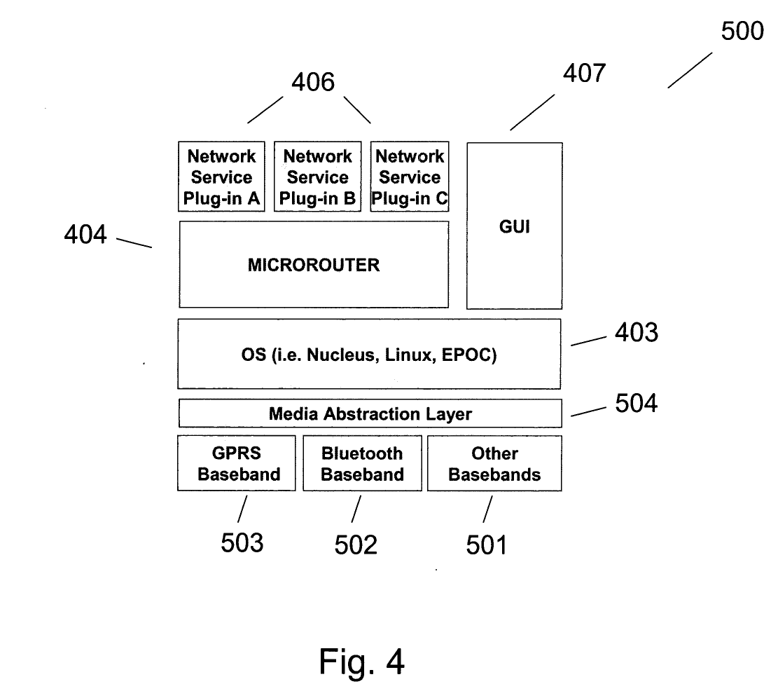

FIG. 4 illustrates a software architecture 500 for device 106 illustrated in FIG. 3a according to an embodiment of the present invention. In an embodiment of the present invention, software 500 is stored in FLASH memory 302. In an embodiment of the present invention, software components referenced in FIGS. 4-8f represent a software program, a software object, a software function, a software subroutine, a software method, a software instance, and a code fragment, singly or in combination. In an alternate embodiment, functions performed by software components illustrated in FIGS. 4-8f are carried out completely or partially by hardware.

In an embodiment of the present invention, software 500, or components of software 500, is stored in an article of manufacture, such as a computer readable medium. For example, software 500 is stored in a magnetic hard disk, an optical disk, a floppy disk, Compact Disk Read-Only Memory (“CD-ROM”), Random Access Memory (“RAM”), Read-Only Memory (“ROM”), or other readable or writeable data storage technologies, singly or in combination. In yet another embodiment, software 500, or components thereof, is downloaded from manager server 102 illustrated in FIG. 1.

Software 500 includes telecommunication software or physical layer protocol stacks, in particular cellular communication software 503 and short-range radio communication software 502. In an embodiment, communication software 503 is a GPRS baseband software component used with processor 306 to transmit and receive cellular signals including data packets. In an embodiment, communication software 502 is a Bluetooth™ baseband software component used with processor 307 to transmit and receive short-range radio signals. Other telecommunication software may be used as illustrated by other basebands 501.

In an embodiment of the present invention, operating system (“OS”) 403 is used to communicate with telecommunication software 502 and 503. In an embodiment of the present invention, operating system 403 is a Linux operating system, EPOC operating system available from Symbian software of London, United Kingdom or a PocketPC or a Stinger operating system available from Microsoft® Corporation of Redmond, Wash. or Nucleus operating system, available from Accelerated Technology, Inc. of Mobile, Ala. Operating system 403 manages hardware and enables execution space for device software components.

Media abstraction layer 504 allows operating system 403 to communicate with basebands 503, 502 and 501, respectively. Media abstraction layer 504 and other abstraction layers, described herein, translate a particular communication protocol, such as GPRS, into a standard command set used by a device and/or terminal. The purpose of an abstraction layer is to isolate the physical stacks from the rest of the device software components. This enables future usage of different physical stacks without changing any of the upper layer software and allows the device software to work with any communication protocol.

Furthermore, Graphics User Interface (“GUI”) 407 is provided to allow a user-friendly interface.

Microrouter 404 and network service plug-in 406 enables an IP based network or enhanced IP based network, respectfully.

A. Microrouter

Microrouter 404 enables an IP based network between device 106 and terminals 107. In an embodiment of the present invention, each terminal can leverage the existing IP protocol, exchange information with other terminals and gain access to a WAN through microrouter 404. Extended network services, such as network service plug-ins 406, may be added to microrouter 404. In an embodiment, manager server 102, installs microrouter 404 and network service plug-ins 406 on device 106.

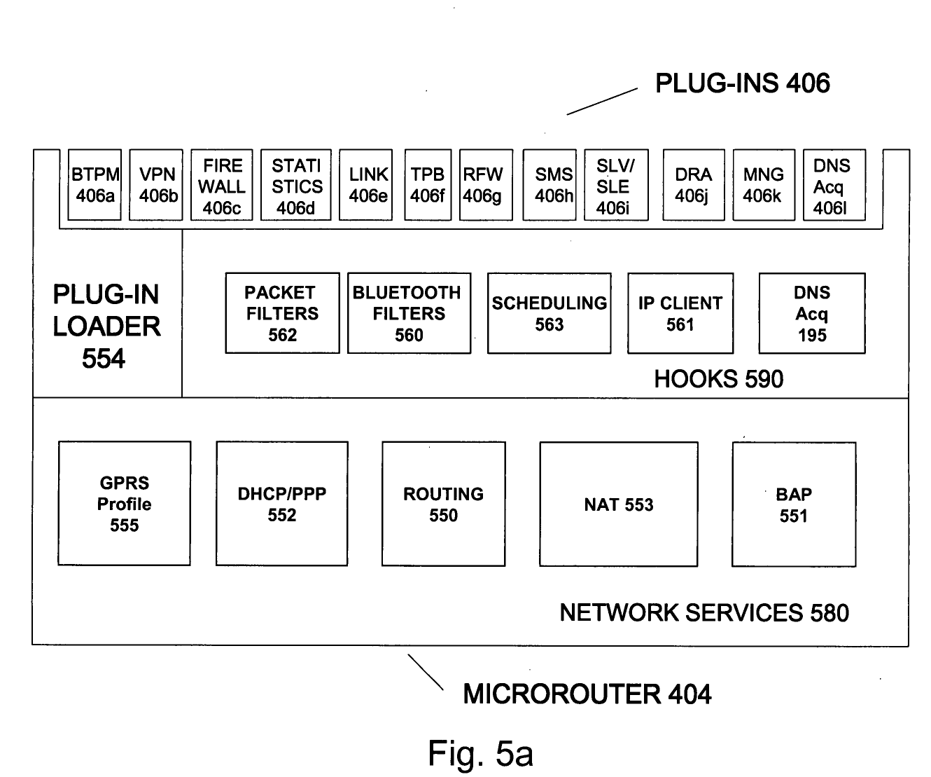

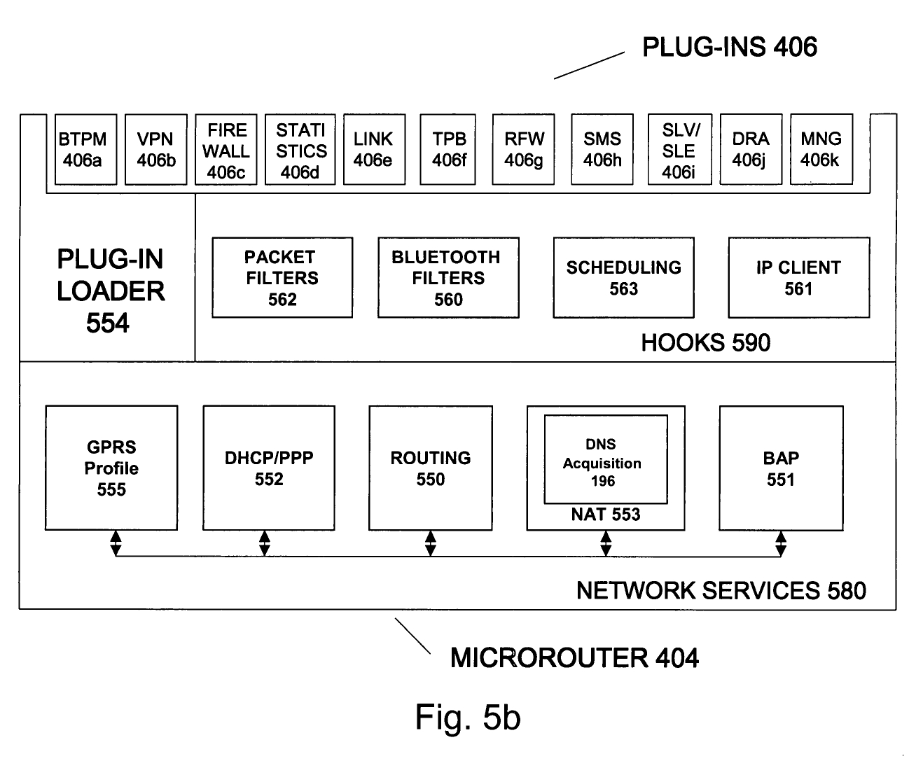

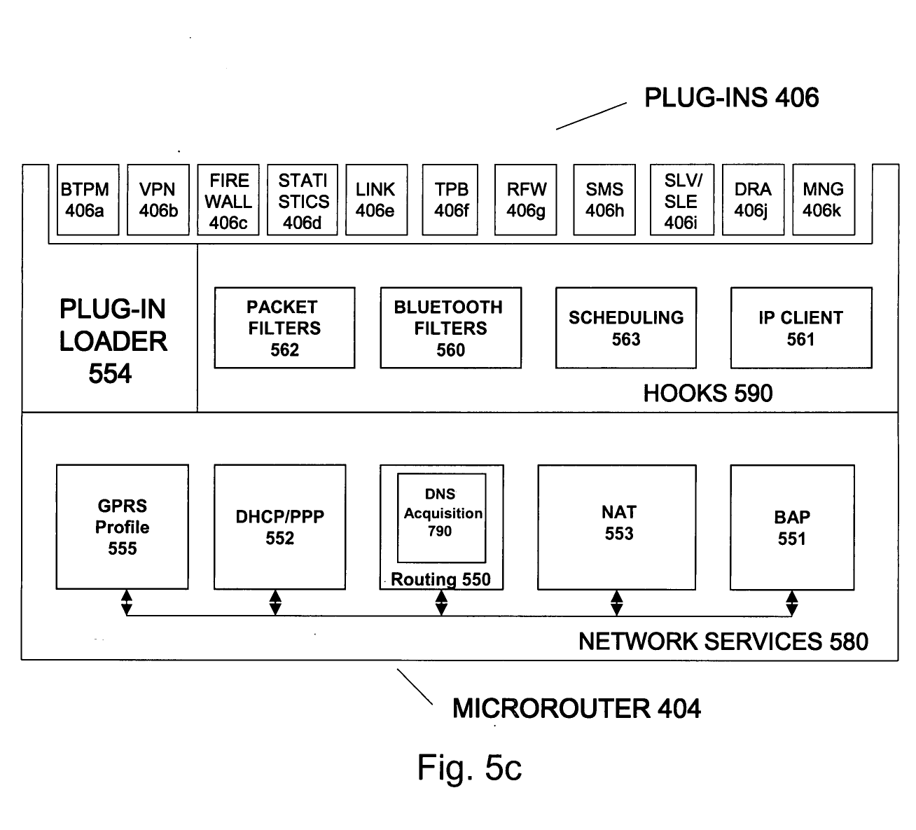

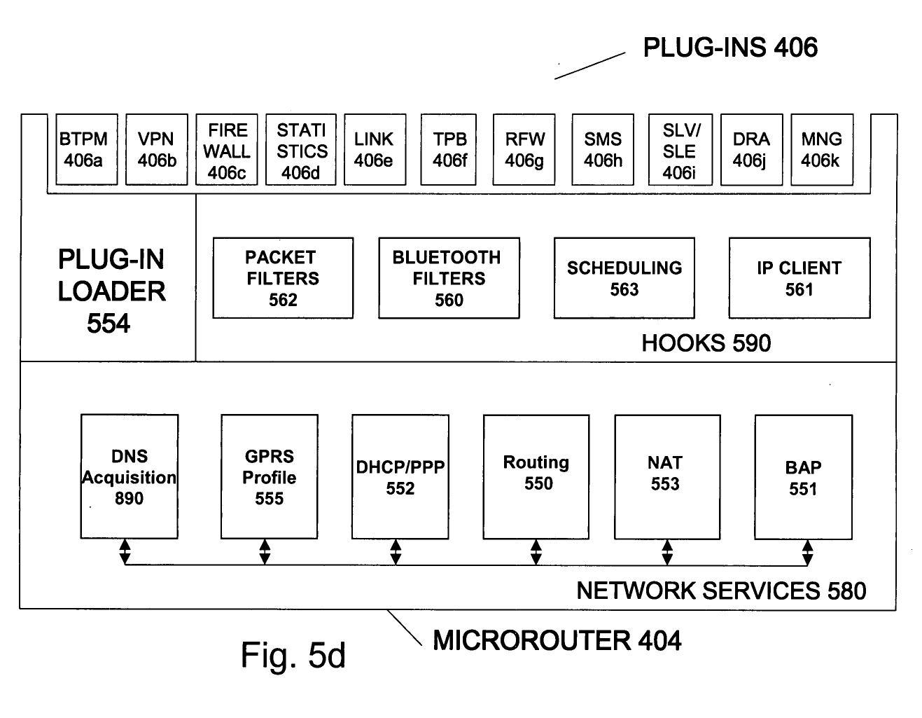

FIG. 5a illustrates software components of microrouter 404. In an embodiment of the present invention, routing software component 550, Bluetooth™ LAN Access Profile software component 551, Point-to-Point Protocol (“PPP”) software component 552 and Network Address Translator (“NAT”) software component 553 are included in microrouter 404. In an alternate embodiment, other software components, such as packet filters 562, Bluetooth™ filters 560, scheduling 563, IP client 561 and DNS Acquisition 195 are included in microrouter 404. In still another embodiment, microrouter 404 includes hooks 590 for adding network services plug-ins 406.

In an embodiment of the present invention, device 106 includes IP address change software for obtaining a public WAN address as described in U.S. patent application Ser. No. 10/435,098, entitled “Device, System, Method And Computer Readable Medium For Fast Recovery of IP Address Change”, filed on May 9, 2003, which is incorporated by reference herein.

In an embodiment of the present invention, device 106 includes cellular connection software for selectively attaching to a short distance wireless network to a cellular network, and in particular a cellular data service as described U.S. patent application Ser. No. 10/619,857, entitled “A Device, System, Method And Computer Readable Medium Selectively Attaching To A Cellular Data Service”, filed on Jul. 14, 2003, which is incorporated by reference herein.

In an embodiment of the present invention, device 106 includes attachment software for simultaneously attaching terminals 107 in short distance wireless network 116 to an APN in WAN 105 as described in U.S. patent application Ser. No. 10/666,776, entitled “A Device, System, Method and Computer Readable Medium For Attaching To A Device Identified By An Access Point Name In A Wide Area Network Providing Particular Services,” filed on Sep. 18, 2003 which is incorporated by reference herein.

1. Microrouter Services

In an embodiment, microrouter 404 services include software components for a short distance wireless network that has access to a WAN. In an embodiment, the software components included in a microrouter 404 are described below.

a. Bluetooth™ Access Profile (“BAP”)

BAP software component 551 enables Bluetooth™ terminals to gain access to short distance wireless network 116 and a WAN by using an IP protocol.

In an embodiment of the present invention, BAP 551 includes implementation of two Bluetooth™ usage profiles such as: 1) Bluetooth™ LAN Access Profile software and 2) Bluetooth™ Dial-Up Profile software.

Bluetooth™ LAN Access Profile software component allows a LAN Access client in a terminal to obtain an private IP address and use the private IP address in order to gain connectivity to other short distance wireless network terminals or to a WAN, behaving as if they were on a short distance wireless network.

Bluetooth™ Dial-Up Profile software component enables a terminal to dial-up to any termination number and get IP services from that termination. In addition, a Bluetooth™ Dial-Up Profile (“DUP”) software component emulates termination in device 106. In an embodiment, microrouter 404 has either a Bluetooth™ LAN Access Profile software component or a Bluetooth™ Dial-Up Profile software component. In an alternate embodiment, microrouter 404 includes both Profile software components. In a Bluetooth™ Dial-Up Profile software component mode, a terminal dials a predefined number, for example 999, for which microrouter 404 will not actually dial the number over a cellular network, but emulates as if the number was dialed and a modem answered the call. Microrouter 404 will provide the terminal with an IP address and access to WAN 105. From the terminal's point of view it is as if the terminal dialed a number 999 to a modem and received an IP service from that modem, but in reality the terminal used DUP to obtain packet switching access to WAN 105 and the call was actually terminated at microrouter 404.

b. Routing

Routing software component 550 is responsible for transferring IP packets either in a short distance wireless network or toward a WAN. In a short distance wireless network 116, Routing software component 550 handles broadcasting IP packets and transferring IP packets between terminals. Routing 550 is also responsible for LAN IP Broadcast emulation.

Routing software component 550 is responsible for IP packet queuing/dropping. An IP packet dropping software component is used for reducing congestion caused by having more than one terminal connected simultaneously. In an embodiment of the present invention, Routing software component 550 includes a queuing software component, Quality of Service software component or equivalent for queuing IP packets. Likewise, Routing software component 550 includes a dropping software component that is configured by manager server 102, a user or any other remote entity. In an embodiment of the present invention, manager server 102 defines and loads an IP packet queuing/dropping software component. An operator 115 will be able to define a particular queuing/dropping software component that is suitable for a particular short distance wireless network 116 or user. A user will have a better short distance wireless network 116, and thus a better user experience, without having to configure or monitor a short distance wireless network 116.

In an alternate embodiment of the present invention, Routing software component 550 is a bridge software component for transferring an IP address.

c. PPP

In an embodiment of the present invention, microrouter 404 includes a PPP software component 552, such as a PPP server that is the termination for a short distance wireless network access profile software component. A PPP server provides IP network information, such as a private IP address, DNS address or the like, to a terminal.

d. NAT

NAT software component 553 is used 1) because only one public IP address or WAN IP source address is typically made available to a cellular telephone and 2) in order to conserve public IP addresses provided by an operator. In an embodiment of the present invention, WAN 105, and in particular, a cellular packet switching network 129, provides device 106 with one public WAN IP address. A short distance wireless network 116 however includes more than one participating terminal. In order to provide IP addresses to all terminals 107, private short distance wireless network IP addresses will be used for short distance wireless network terminals while NAT 553 is responsible for translations between private short distance wireless network IP addresses and public WAN IP sources addresses, and vice versa.

e. GPRS Profile

GPRS profile software component 555 is responsible for obtaining IP packets in a GPRS format received by device 106 by way of cellular network 129 and providing the received IP packets to routing software component 555 for transfer to one or more terminals 107 and/or device 106. In an embodiment of the present invention, a GPRS packet is received from APN 190 that provides a DNS address 101b. In an embodiment of the present invention, a GPRS packet, including DNS information, is received from an APN associated with DNS software component 801 stored on DNS server 101a. Likewise, GPRS software profile software component 555 is responsible for preparing IP packets from one or more terminals 107 and/or device 106 for transferring to a particular APN. GPRS profile software component 555 is also responsible for attaching, or obtaining a public IP address for device 106 in response to a control signal. In an embodiment of the present invention, GPRS profile software component 555 obtains a public IP address from APN 190. Similarly, GPRS profile software component 555 is also responsible for disconnecting, or releasing a previously assigned public IP address responsive to a control signal.

f. DNS Acquisition Software

In embodiments of the present invention, a DNS Acquisition software component 195 is included in hooks 590 and/or as plug-ins 406, in particular DNS Acquisition software component 4061 as illustrated in FIG. 5a. In another embodiment of the present invention, DNS Acquisition software component 196 is included in NAT software component 553 as illustrated in FIG. 5b. In an alternate embodiment of the present invention, DNS Acquisition software component 790 is included in Routing software component 550 as illustrated in FIG. 5c. In this embodiment, DNS Acquisition logic 651 is included in Routing software component 550 in order to access queued data packets from respective terminals. In still another embodiment, DNS Acquisition software component 890 is a separate software component and not included in either NAT software component 553 or Routing software component 550. As one of ordinary skill in the art would appreciate, the functions of DNS Acquisition software components 195, 196, 4061, 790, and 890 are included, singly or in combination, in other software components of microrouter 404 and/or software architecture 500 in alternate embodiments of the present invention.

Arrows shown in FIGS. 5a-d represent flow of data and/or control signals between software components. In alternate embodiments of the present invention, software components shown in FIGS. 5a-d communicate by reading values in memory locations or generate/receive a message that is represented by the arrows. For example, the arrow from NAT software component 553 to GPRS Profile software component 555 represents a first DNS Acquisition message generated by DNS Acquisition software component 196 to obtain a DNS address 101b at APN 190. A second DNS Acquisition message is generated by DNS Acquisition software component 196 to GPRS Profile software component 555 to obtain a DNS from DNS server 101a. As one of ordinary skill in the art would appreciate, more or less communication of data and/or control or arrows between software components may be used in alternate embodiments of the present invention.

In embodiments of the present invention, DNS Acquisition software components 195, 196, 4061, 790 and/or 890 obtain a current network attribute, such as DNS address 101b, for a short distance wireless network 116. In an embodiment of the present invention, a network attribute is obtained in response to a short-range radio signal form a terminal in terminals 107. For example, PDA 107b may generate a message by way of short-range radio signals 110 that includes a host name that must be translated into an IP address.

FIG. 5b illustrates an embodiment of the present invention in which DNS Acquisition software component 196 is included in NAT software component 553. BAP software component 551 and/or DHCP/PPP software component 552 generate a control signal to DNS Acquisition software component 196 indicating that a terminal in terminals 107 is requesting a DNS by way of contents of a short range radio message or signal 110 from the respective terminal. DNS Acquisition software component 196 then generates a control signal to GPRS Profile software component 555 responsive to a determination that a current DNS address 101b must be obtained. GPRS Profile 555 then obtains a DNS address 101b at APN 190 and transfers the DNS address 101b to DNS Acquisition software component 196. DNS Acquisition software component 196 then generates a control signal to DHCP/PPP software component 552, Routing software component 550 and/or BAP software component 551 to transfer the current DNS address 101b to the requesting terminal. DNS Acquisition software component 196 also generates a control signal to DHCP/PPP software component 552, Routing software component 550 and/or BAP software component 551 to terminate a communication between one or more terminals 107 and device 106 when obtaining a current DNS address 101b, as describe below, in an embodiment of the present invention.

FIG. 5a illustrates DNS Acquisition software component 195 and 4061 in embodiments of the present invention. In embodiments of the present invention, either DNS Acquisition software component 195 or 4061 functions as described above in regard to DNS Acquisition software component 196. In an embodiment of the present invention, DNS software component 4061 is downloaded and monitored by manager server 101 executing manager software 700. In an embodiment of the present invention, DNS Acquisition software component 195 is an Application Program Interface (“API”).

Similarly, FIGS. 5c and 5d illustrate DNS Acquisition software components 790 and 890, respectively, that operate similarly to DNS Acquisition software component 196 described above.

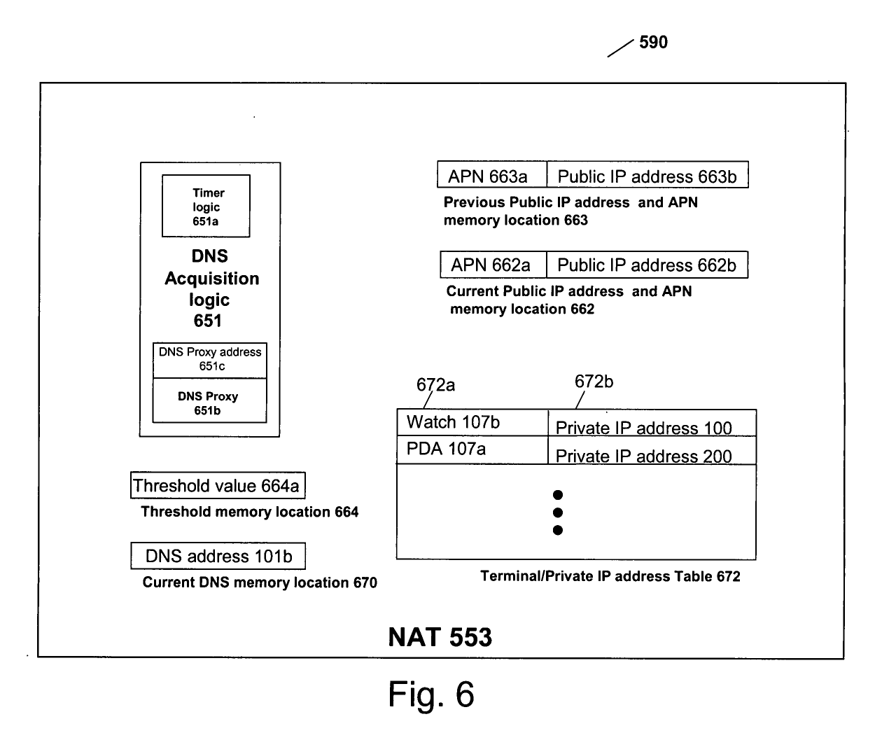

FIG. 6 illustrates a detailed view of DNS Acquisition software component 195, 196, 4061, 790 or 890 in embodiments of the present invention. DNS Acquisition software components 4061, 195, 196, 790 or 890 includes DNS Acquisition logic 651, Previous Public IP address and APN memory location 663 (that stores a previous APN 663a and Public IP address 663b), Current Public IP address and APN address memory location 662 (that stores a current APN 662a and Public IP address 662b), Current DNS memory location 670 (that stores the current DNS address 101b for a DNS server 101a), Threshold memory location 664 (that stores a threshold value 664a) and Terminal/Private IP address table 672 in embodiments of the present invention.

In an embodiment of the present invention, DNS Acquisition logic 651 is responsible for making a determination as to whether to generate control signals for obtaining a current DNS address 101b. In an embodiment of the present invention, logic 651 stores current and previous Public IP addresses 662b and 663b as well as current APN 662a and previous APN 663a at memory locations 662 and 663, respectively. Logic 651 then generates a control signal responsive to a comparison of the values stored in memory locations 663 and 662 at device 106 power-up. In an alternate embodiment of the present invention, logic 651 generates a control signal at device 106 power-up without a comparison of the values at memory locations 662 and 663. A current DNS address 101b is then obtained by way of GPRS Profile software component 555 and stored in memory location 670 if the values of memory location 663 and 662 are different. A current DNS address 101b stored at memory location 670 then may be transferred to the appropriate terminal in terminals 107 by software components BAP 551, DHCP/PPP 552 and Routing 550 responsive to control signals generated by logic 651.

Table 672, stored in a plurality of memory locations, includes a list of terminals in short distance wireless network 116 shown in column 672a, and assigned respective private IP addresses used by NAT software component 553 in an embodiment of the present invention. APN values or addresses are also stored in DNS Acquisition software components 195, 196, 4061, 790 or 890 in embodiments of the present invention. A manufacturer or distributor in an embodiment of the present invention stores these APN values. In an alternate embodiment of the present invention, the available APNs are loaded from manager software 700 shown in FIG. 7a.

In an alternate embodiment of the present invention, logic 651 includes timing logic 651a for comparing a measured time with a time threshold value stored at memory location 664. Logic 651 generates a control signal to initiate and maintain a session (attach) using GPRS Profile software component 555 that will obtain DNS address 101b. Logic 651a measures the amount of time device 106 has not been attached to a GPRS service that may obtain a DNS address 101b. If the measured amount of time exceeds threshold value 664a, for example 24 hours, logic 651a generates a control signal to GPRS Profile software component 555 to obtain DNS address 101b. This embodiment is preferred when network attributes do not change frequently.

In an alternate embodiment of the present invention, DNS Acquisition software components 195, 196, 4061, 790 or 890 act as a DNS proxy. For example, DNS logic 651 includes DNS proxy 651b at DNS proxy address 651c for providing a translation between host names or domains and IP addresses for terminals 107. In an embodiment of the present invention, terminals 107 are provided with DNS proxy address 651c for a DNS proxy 651b. When a GPRS service is available or attached by GPRS Profile 555, DNS proxy 651b relays a DNS request by a terminal to DNS server 101a after obtain current DNS address 101b.

In still an alternate embodiment of the present invention, DNS Acquisition software components 195, 196, 4061, 790 or 890 provides the best known DNS address, and in particular the last known DNS address, to a requesting terminal. For example, DNS logic 651 provides a requesting terminal with a potentially stale stored DNS address in device 106. When a GPRS service is available or attached by GPRS Profile 555a stored DNS address is compared to a retrieved current DNS address 101b. If the retrieved current DNS address 101b is different than the stored DNS address at memory location 670, device 106 terminates communication with terminals 107 that requested a DNS address. In embodiments of the present invention, terminals 107 then obtain the current DNS address 101b by either a requesting terminal or device 106 reinitiating a session after the termination.

In an embodiment of the present invention, device 106 terminates a connection or communication between device 106 and a requesting terminal in terminals 107 by either 1) disconnecting all PPP connections between device 106 and requesting terminals 107, 2) disconnecting PPP connections on which a TCP connection resides for requesting terminals, 3) disconnecting TCP connections without disconnecting PPP connections for requesting terminals or 4) generating a simulated FIN message to a requesting terminal.

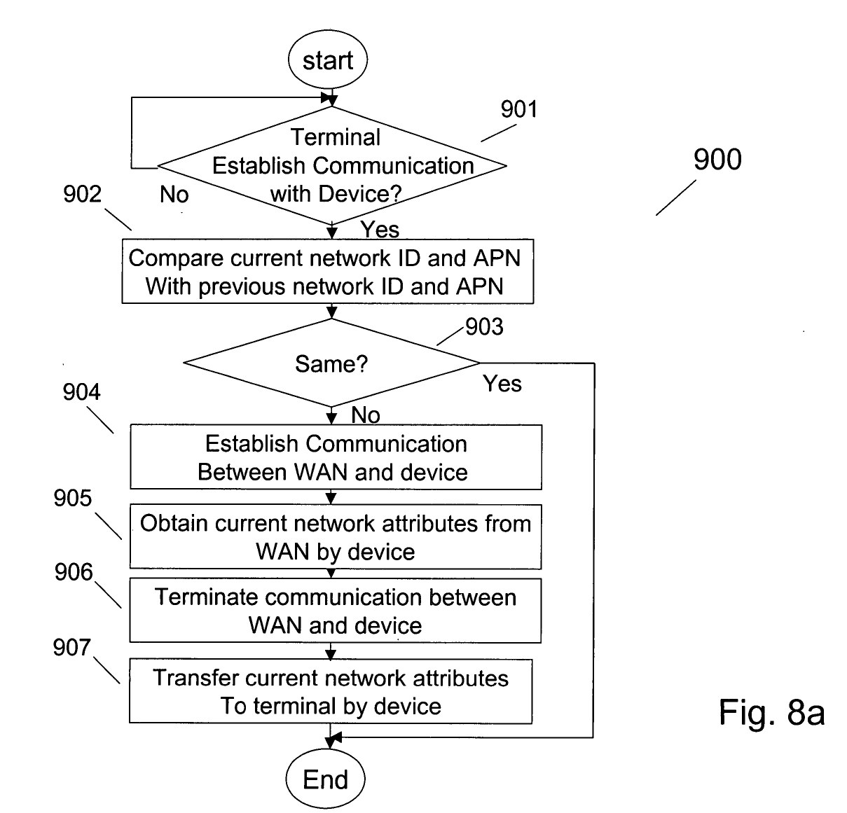

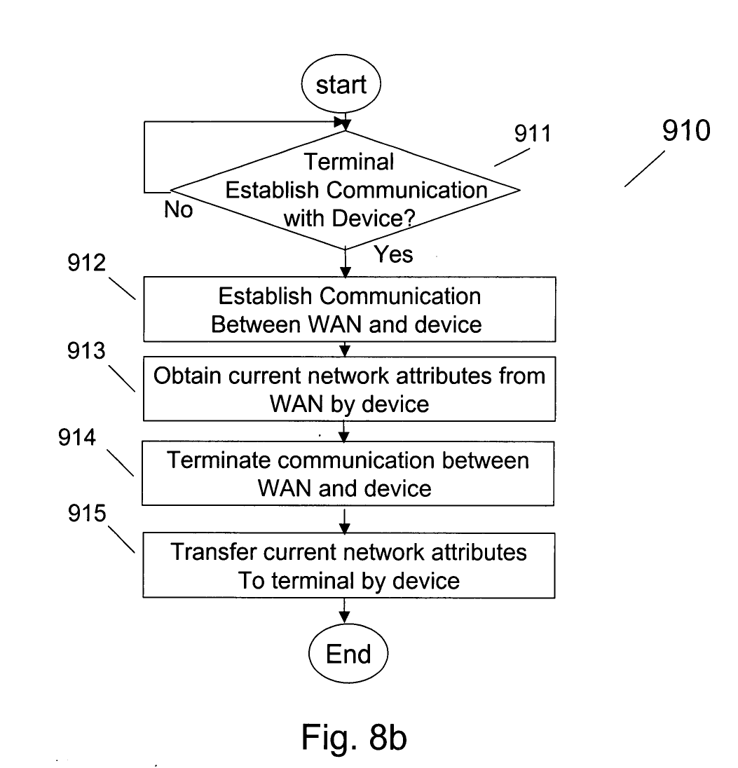

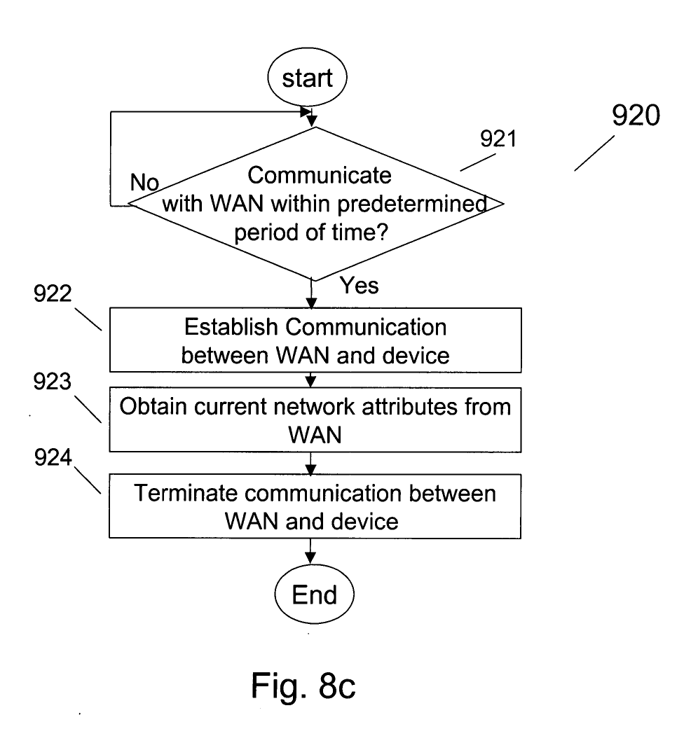

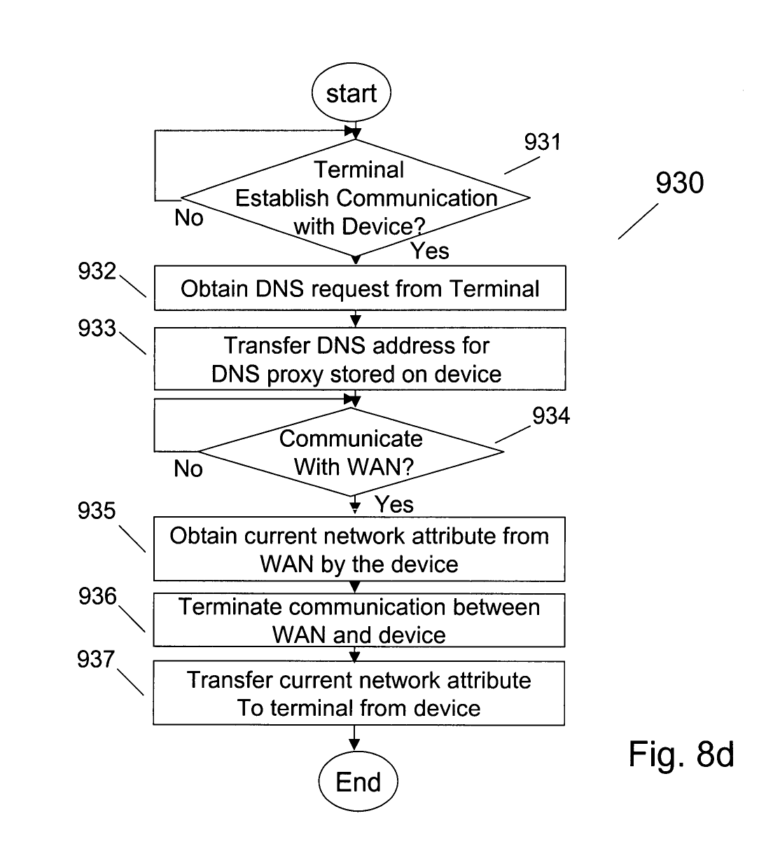

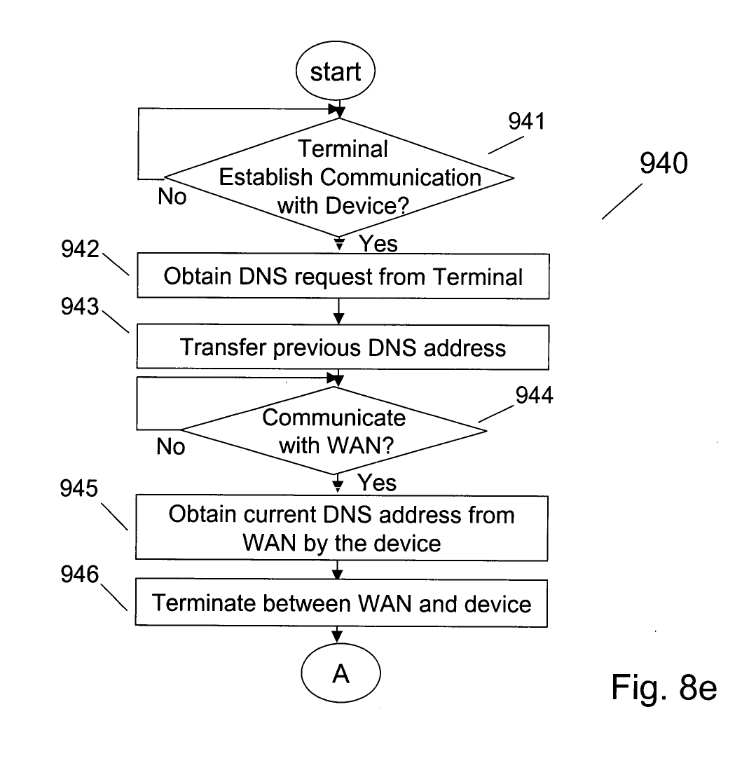

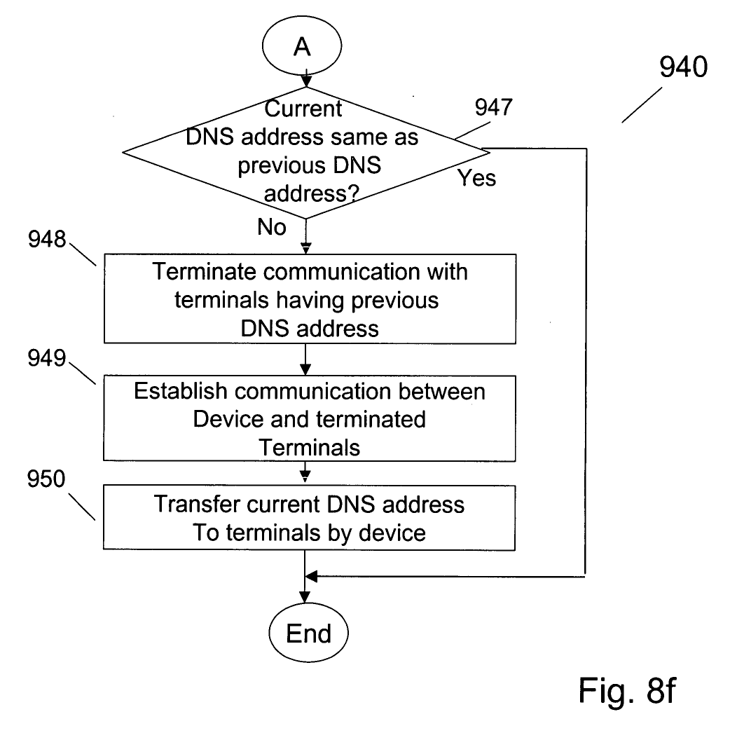

FIGS. 8a-f illustrate methods for obtaining a network attribute, such as a DNS address, from a WAN for a terminal in a short distance wireless network according to an embodiment of the present invention. In an embodiment, a method is performed, in part or completely, by software components illustrated in FIGS. 4-7a-b. In an embodiment of the present invention, a logic block or step illustrated in FIGS. 8a-f may represent an execution of a software component, such as a software program, a software object, a software function, a software subroutine, a software method, a software instance, a code fragment singly or in combination. In an alternate embodiment of the present invention, logic block or step represents execution of a software component, hardware operation, or user operation, singly or in combination. In an alternate embodiment of the present invention, fewer or more logic blocks or steps are carried out in the methods illustrated in FIGS. 8a-f.

FIG. 8a illustrates a method 900 for obtaining a network attribute from a WAN for a short distance wireless network according to an embodiment of the present invention. In an embodiment of the present invention, a network attribute is a DNS address 101b of a DNS (DNS server 101a) in WAN 105 for short distance wireless network 116 as seen in FIG. 1. Method 900 begins by determining whether communication has been established between a terminal 107 and device 106 as shown by logic block 901. In an embodiment of the present invention, communication is established by device 106 receiving a short-range radio message from a terminal in a short distance wireless network 116. In an embodiment of the present invention, the short-range message includes a request for a DNS address, a host name or domain name that needs translation to a public IP address or a request that requires a DNS address.

In an embodiment of the present invention, DNA Acquisition software 196 determines if communication is established between device 106 and one or more terminals 107 as illustrated by logic block 901. In an embodiment of the present invention, BAP 551 and/or DHCP/PPP 552 software components generates a control signal to DNS Acquisition software component 196 when communication is established between one of terminals 107 and device 106. If communication is established, control passes to logic block 902; otherwise, logic block 901 is repeated. In logic block 902, a comparison is made between a stored current public IP address and current APN for device 106 and a stored previous public IP address and previous APN. In an embodiment of the present invention, a current public IP address and current APN are obtained from WAN 105 when device 106 is powered up and in coverage of cellular network 129 with or without a terminal establishing communication with the device. In an embodiment of the present invention, server 101, as seen in FIG. 1, provides a public IP address and APN for device 106. In an embodiment of the present invention, DNS Acquisition logic 651, as seen in FIG. 6, compares the contents of memory locations 662 and 663. If values are the same, control passes to logic block 904; otherwise, method 907 ends.

In logic block 904, communication is established between a WAN and a device. In an embodiment of the present invention, device 106 establishes communication with WAN 105, and in particular cellular network 129, as seen in FIG. 1. In an embodiment of the present invention, device 106 establishes communication with server 101 at APN 190 that provides DNS address 101b. In an embodiment of the present invention, DNS Acquisition software component 196 generates a control signal to GPRS profile software component 555 for obtaining DNS address 101b from APN 190. In an embodiment of the present invention, communication is established, at least in part, by cellular signals 111.

In logic block 905, a network attribute is obtained. In an embodiment of the present invention, a DNS address 101b to a DNS server 101a is obtained by device 106. In an embodiment of the present invention, GPRS profile software 555 is used to obtain DNS address 101b responsive to a control signal from DNS Acquisition software component 196. The obtained DNS address 101b is then passed to DNS software component 196 where it is stored in memory location 670. DNS software then generates a control message to GPRS software 555 to terminate a session with APN 190 as illustrated by logic block 906.

In logic block 907, DNS address 101b is transferred to a terminal requesting a DNS. In an embodiment of the present invention, the DNS address is transferred to a terminal by short-range radio signals 110 using BAP 551 and DHCP/PPP 552. Method 900 then ends FIG. 8b illustrates a method 910, similar to method 900, according to an embodiment of the present invention. However, method 920 does not include a step of comparing a current public IP address and current APN with a previous public IP address and previous APN. Method 910 begins by determining whether a terminal, such as a terminal in terminals 107, establishes communication with a device, such as device 106, as illustrated by logic block 911. Communication between a device and a WAN is established as illustrated by logic block 912. A network attribute is then obtained from a WAN as illustrated by logic block 913. Communication between the device and the WAN is then terminated and the current network attribute is transferred to the terminal as illustrated by logic blocks 914 and 915, respectively. Method 910 then ends.

FIG. 8c illustrates a method 920 according to an embodiment of the present invention. Method 920 initiates by determining if a device, such as device 106, has communicated or attached to a WAN within a predetermined period of time as illustrated by logic block 921. In an embodiment of the present invention, timer logic 651a is used with threshold value 664a to determine whether device 106 has been attached to a GPRS service within a period of time stored as threshold value 664a. If the threshold value 664a is exceeded, communication is established between a WAN and a device as illustrated by logic block 922. A network attribute is then obtained from a WAN as illustrated by logic block 923. Communication between the device and the WAN is then terminated and the current network attribute is transferred to the terminal as illustrated by logic blocks 924 and 925, respectively. Method 920 then ends.

FIG. 8d illustrates a method 930 according to an embodiment of the present invention. Method 930 begins by determining whether a terminal, such as a terminal in terminals 107, establishes communication with a device, such as device 106, as illustrated by logic block 931. A device obtains a DNS request from a terminal as illustrated by logic block 932. In an embodiment of the present invention, device 106 receives a short-range radio message from a terminal in terminals 107 requesting a translation of a host name to a public IP address. A device then transfers a DNS proxy address for a DNS proxy stored in the device, such as device 106, to the terminal as illustrated by logic block 933. In an embodiment of the present invention, device 106 transfers a DNS proxy address 651c for DNS proxy 651b in DNS Acquisition logic 651 stored in microrouter 404. The terminal then may obtain a DNS for a host name by accessing DNS proxy 651b at DNS proxy address 651c.

A determination is made whether communication between a device and a WAN is established as illustrated by logic block 934. In an embodiment of the present invention, a determination is made whether device 106 is attached to a GPRS service. If communication is established, control passes to logic block 935 were a current DNS address is obtained from a WAN. Otherwise, logic block 934 is repeated. Communication between the device and the WAN is then terminated and the current network attribute, such as a current DNS address, is transferred to the terminal from the device as illustrated by logic blocks 936 and 937, respectively. Method 930 then ends.

FIGS. 8e and 8f illustrate a method 940 according to an embodiment of the present invention. Method 940 begins by determining whether a terminal, such as a terminal in terminals 107, establishes communication with a device, such as device 106, as illustrated by logic block 941. A device obtains a DNS request from a terminal as illustrated by logic block 942. In an embodiment of the present invention, device 106 receives a short-range radio message from a terminal in terminals 107 requesting a translation of a host name to a public IP address or a message requiring a translation. A device then transfers a previous DNS address or the last known DNS address stored in device 106 to the terminal as illustrated by logic block 943.

A determination is made whether communication between a device and a WAN is established as illustrated by logic block 944. In an embodiment of the present invention, a determination is made whether device 106 is attached to a GPRS service in WAN 105. If communication is established, control passes to logic block 945 were a current DNS address is obtained from a WAN by a device. Otherwise, logic block 934 is repeated. Communication between the device and the WAN is then terminated as illustrated by logic block 946.

A determination is made whether the obtained current DNS address is the same as the previously stored DNS address as illustrated by logic block 947. If the current and previous DNS addresses are the same, method 940 ends. Otherwise, control passes to logic block 948 where communication between the terminals having the previous DNS address and the device is terminated. Communication is then established or reinitiated by the device or the terminals having the previous DNS address as illustrated by logic block 949. The current DNS address is then transferred to the terminals as illustrated by logic block 950. Method 940 then ends.

In an alternate embodiment of the present invention, an application software component in device 106 requests a DNS address or public IP address for a domain and DNS Acquisition software component 195, 196, 4061, 790 or 890 provides the DNS address or public IP address for a domain name responsive to a request from the application software component in embodiments of the present invention. For example, watch 107a is a terminal that accesses a watch application software component on device 106. A watch application software component provides messages and/or information to watch 107a responsive to user interaction or short-range radio messages from watch 107a. A user may indirectly request a DNS address or public IP address for a domain name by a user entry at watch 107a or watch 107a requests information from the corresponding watch application software component stored on device 106 that then initiates obtaining a DNS address or public IP address for a domain name in order to provide the requested information to watch 107a.

2. Hooks to Extended Network Service Plug-Ins

In an embodiment of the present invention, microrouter 404 includes hooks 590 allowing for the extension of microrouter 404 networking services, such as plug-ins 406. In an embodiment of the present invention, hooks 590 are APIs for plug-ins 406.

In an embodiment of the present invention, microrouter 404 is programmed to have only basic network abilities and a very low footprint, or in other words require very little memory, for example 100 K bytes, in order to be stored in a device 106, such as a cellular telephone. However, in some instances more network services will be needed. Further, operators may want the ability to add and sell network services after the device 106 is sold and in operation without user intervention. A user may be less likely to purchase a network service if the user has to return device 106 to the manufacturer or an inconvenient site.

For these and other reasons, the microrouter 404 includes hooks 590 that enable plug-ins 406 to be implemented in an embodiment of the present invention. This plug-in capability does not define a full execution environment but defines a small framework for implementing code, which can plug-in and extend microrouter 404 network services. In an embodiment of the present invention, hooks 590 are not a user application framework, plug-in code abilities are limited and serve only as an extension to network services.

Plug-ins 406 are fully activated by microrouter 404, which has full control over them in an embodiment of the present invention. In some sense, plug-ins are like a Dynamic Link Library (“DLL”) that have a predetermined set of functions that a microrouter can call in order for them to realize the needed functionality.

Below describes software components included in hooks 590 for implementing plug-ins 406 according to an embodiment of the present invention. In an alternate embodiment, other software components are included or replace illustrated software components in hooks 590. For example, software components implementing functionality used by all plug-ins 406, such as hooks for centralized configuration and backend connectivity, are included in hooks 590 in an embodiment of the present invention. These included software components in hooks 590 will save resources and allow for efficient operation.

a. Packet Filters

Packet filters software component 562 allows plug-ins 406 to process IP packets going either internally in a short distance wireless network 116 or externally to and from a WAN. By enabling plug-ins 406 to process IP packets, change any part of a packet, drop a packet or generate more packets, microrouter 404 is able to include multiple other added extended network services. For example, microrouter 404 is able to include a VPN, a firewall, tag packets, monitor packets and other extended network services described below. In an embodiment of the present invention, packet filters 562 is a data path for transferring IP packets that are accessible by plug-ins 406.

b. Bluetooth™ Filters

Bluetooth™ filters software component 560 enables plug-ins 406 to process Bluetooth™ information. In an embodiment, Bluetooth™ filters 560 processes a pairing request event and provides a PIN number. In an embodiment of the present invention, Bluetooth™ filters 560 enables added network services such as PIN management, denying access to a short distance wireless network 116 from a terminal, authenticating a terminal, pairing through an interactive voice response (“IVR”) system or the Internet. In an embodiment of the present invention, a Bluetooth™ filter 560 is a data path for transferring Bluetooth™ information that is accessible by plug-ins 406.

c. Scheduling

In order for plug-ins 406 to be able to generate events, traffic or do periodic tasks, a scheduling software component 563 enables a plug-in to receive a callback periodically or when required by the plug-in. For example, Scheduling software component 563 enables a statistics plug-in to send statistic information on terminal and application usage every X hours or calculate average traffic at a selected terminal.

d. IP Client

In an embodiment of the present invention, IP Client software component 561 makes available IP services to plug-ins 406 so a plug-in can obtain an IP address, send IP packets and/or receive IP packets. Thus, IP Client software component 561 enables a plug-in to obtain a private IP address from microrouter 404 and connect to a backend server, such as manager server 102. An IP client 561 can implement a TCP/IP stack or User Datagram Protocol (“UDP”). In an embodiment of the present invention, IP Client plug-in 561 uses all necessary microrouter 404 network services, such as packet filters 562 or NAT 553. From a microrouter 404 perspective, an IP Client 561 is treated like any other terminal on a short distance wireless network 116.

3. Plug-In Loader

A plug-in can be attached to a microrouter 404 during or after manufacturing. In an embodiment of the present invention, a plug-in is stored or programmed in device 106 before shipping from a manufacturer. Alternately, a plug-in is downloaded from manager server 102 at run-time over WAN 105.

A Plug-In Loader software component 554, as illustrated in FIG. 5a, is responsible for loading plug-ins 406, programming of plug-ins 406 and notification of newly available plug-ins 406 to microrouter 404 in an embodiment of the present invention.

In an embodiment of the present invention, Plug-In Loader 554 will use operating system 403 capabilities for programming a file system and access of plug-ins 406. In an alternate embodiment of the present invention, Plug-In Loader 554 uses a plug-in directory in a dedicated memory space of device 106.

4. Microrouter Extended Service Plug-Ins

Below describes microrouter 404 extended service plug-ins 406 in an embodiment of the present invention. In various embodiments of the present invention, one or more of plug-ins 406 are attached to microrouter 404. In alternate embodiments, other plug-ins are attached to microrouter 404. In an embodiment of the present invention, a device manufacturer, terminal manufacturer, an operator 115 and/or other third party provides a plug-in.

a. Bluetooth™ Terminal Pairing Management (“BTPM”)

BTPM software component plug-in 406a is responsible for PIN management and authenticating terminals for participating in a short distance wireless network 116. BTPM 406a allows an operator 115 to control which terminal can connect to a short distance wireless network 116. For example, an operator 115 can deny a terminal from pairing to a short distance wireless network 116, or can approve a terminal for pairing. In an embodiment of the present invention, pairing is done over an IVR, the Internet and/or by a user.

b. VPN

VPN software component plug-in 406b enables a secure link to a network, such as a private corporate network. VPN enables terminals to connect to a corporate file server, exchange server or an equivalent. VPN 406b uses packet filters 562 in order to identify packets that are routed to a corporate LAN IP subnet. In an embodiment of the present invention, VPN 406b then encrypts and tunnels the identified IP packets.

c. Firewall

Firewall software component plug-in 406c protects a short distance wireless network 116 from intruders and hackers. In an embodiment of the present invention, Firewall 406c uses packet filters 562 for identifying IP packets from non-authorized sources and IP packets that are sent to non-authorized servers. In an embodiment of the present invention, firewall 406c enables Uniform Resource Locator (“URL”) filtering.

d. Statistics

In an embodiment of the present invention, Statistics software component plug-in 406d collects usage profiles and statistics on 1) which terminal in a short distance wireless network 116 is used, 2) how much traffic is generated by each terminal, and 3) how much traffic is generated by each application. Statistics 406d enables an operator 115 to promote used terminals and build billing schemes.

e. Link Optimizations

Implementing direct TCP/IP and Internet application protocols over WAN 105, and in particular a wireless network, produces poor performance because of low bandwidth, transmission delays and high data error rates. In order to solve the poor performance but still enable terminals to use standard TCP/IP, a Link Optimization software component plug-in 406e is provided. Link Optimization 406e traps all TCP/IP and specific Internet application protocols, such as Simple Mail Transfer Protocol (“SMTP”) and Hypertext Transfer Protocol (“HTTP”), and converts the protocol to an optimized protocol. Link Optimization 406e then sends the converted packets to a backend server, such as manager server 102, which then deconverts the packets and sends them onto the Internet. In an embodiment of the present invention, terminals and users are not aware of using Link Optimization 406e.

f. Reverse Firewall

As opposed to a typical LAN firewall that protects a short distance wireless network 116 from intruders and hackers from the Internet or another network, a Reverse Firewall (“RFW”) software component plug-in 406g protects an operator 115 or another network from terminals and applications on a short distance wireless network 116 generating traffic toward those networks. RFW 406g enables an operator 115 or another entity to define and enforce usage policies for applications/terminals on a short distance wireless network 116. RFW 406g prevents unnecessary costly transmission costs. Enforcement of usage policies at the short distance wireless network level (i.e. at device 106) prevents expensive packets from going through a cellular network that will be eventually dropped. Further, packets that may be later dropped do not use the limited cellular transmission bandwidth.

In an embodiment of the present invention, RFW 406g is attached to a cellular handset that has Bluetooth™ capability for implementing a short distance wireless network 116 and GSM/GPRS for cellular access to a WAN 105 (i.e. Internet or any other network). RFW 406g is programmed to drop packets based on the originating terminal, originating application/terminal pair or original application. For example, if a user has a PDA and a Notebook, an operator 115 can configure for File Transfer Protocol (“FTP”) packets from the PDA to be dropped if FTP from a PDA is not allowed, or for example to drop video streaming packets originated from the Notebook if video streaming is something the operator 115 does not allow.

Another example includes blocking Notebook usage of such software as Napster in order to avoid cellular unintended usage by users and associated cost.
g. Terminal Programming over Bluetooth™ (“TPB”)

TPB software component plug-in 406f enables the programming of terminals 107 over Bluetooth™ and over a cellular network. In an embodiment of the present invention, programming a terminal is accomplished by “flashing” or programming EEPROM memory in a terminal. An operator 115 or manufacturer can transfer a flash image to be flashed to device 106 having microrouter 404, and terminals 107 to be flashed. TPB 406f communicates with a Flashing software component in a terminal to 1) initiate the flashing process, 2) authenticate the flash image and 3) secure the flashing process.

In an embodiment of the present invention, flashing is done by transferring a full flash image. Alternatively, if there is not enough memory for the full flash image in device 106, the flash image is transferred block by block to eventually be flashed.

TPB 406f enables customizing a terminal, fixing software running on a terminal, and adding applications and/or improvements.

h. Short Message System (“SMS”) Plug-In

SMS software component plug-in 406h allows terminals 107 to send messages between each other in a short distance wireless network 116. In an embodiment of the present invention, a terminal is a Messaging Terminal that enables Instant Messaging over IP. In an alternate embodiment of the present invention, SMS 406h enables standard legacy SMS or Instant Messaging over SMS.

In an embodiment of the present invention, SMS 406h is an SMS server for terminals 107 and an SMS termination for device 106. In this way, a protocol will be defined that enables each terminal to send a packet to SMS 406h with a destination device phone number+message text. SMS 406h then sends the SMS message to a cellular network.

SMS 406h also serves as an SMS receiver in an embodiment of the present invention. A terminal can inquire SMS 406h for received SMS messages and fetch those messages. In still another embodiment of the present invention, a terminal will also receive an IP broadcast message each time an SMS message is received by device 106.

i. Service Level Verification (“SLV”)/Enforcement (“SLE”)

SLV/SLE software component plug-in 406i enables an operator 115 to verify and enforce service level agreements with users. If an operator 115 wants to enforce service levels, such as specifically limiting the amount of traffic over a cellular network, SLV/SLE 406i is added in order to avoid usage of expensive airtime.

In an embodiment of the present invention, SLV/SLE 406i allows a user to generate an unlimited amount of cellular traffic from device 106 during the night but a limited amount during the day. So during the day, if the limited amount is exceeded no more traffic can be generated from device 106 and packets are dropped by SLV/SLE 406i. Similar policies may likewise be enforced. SLV/SLE 406i also identifies and notifies operator 115 of missed cellular network usage by a particular user due to enforcement in an embodiment of the present invention.

j. Device Resources Access (“DRA”)

DRA software component plug-in 406j enables terminals to gain access (according to defined restrictions) to device 106 resources. This enables a terminal to implement a Device Resources Access protocol over IP in order to gain access to any of the following resources: 1) phone book, 2) play a ring tone, 3) initiate a call, 4) user interface, or 5) other device resources.

DRA 406j enables a terminal to read/modify/add phone book entries in a phone book stored on device 106. In a preferred embodiment, a vCard format is used to exchange entry information between device 106 and terminals 107. This enables a better consistent experience for users. For example, DRA 406j provides a user immediate access to a device 106 phone book entries for sending a message from a messaging terminal without having to type the contact information from the phone book.

DRA 406j enables a user to be alerted by using a device 106 ring buzzer. Thus, a terminal in short distance wireless network 116 can use a device 106 ring buzzer for alerting a user.

DRA 406j enables a terminal, such as a PDA or an Outlook application on a notebook computer, to initiate a telephone call at device 106. In an embodiment of the present invention, clicking a phone icon near a phone number on a notebook display initiates a cellular telephone call.

Likewise, DRA 406j enables a terminal to interact with a user through device 106 menus and input components.

k. Terminal Management/Monitoring (“MNG”)

MNG software component plug-in 406k enables management, configuration and monitoring of terminals 107 in an embodiment of the present invention. Instead of each terminal implementing a proprietary management protocol and console, each terminal exposes a “registry” of parameters and MNG 406k implements a protocol enabling a managing server 102 to browse this registry, get values and set values.

1. DNS Acquisition (“Acq”)

DNS Acquisition software component 4061 enables terminals 107 to obtain a DNS in an embodiment of the present invention. In an embodiment of the present invention, DNS Acquisition software component 4061, stored in device 106, obtains a DSN address 101b from WAN 105 that then is transferred to terminals 107 in a short distance wireless network. In an alternate embodiment of the present invention, DNS Acquisition software component 4061 includes a cache for storing recent IP addresses that may be provided to terminals 107 in response to a DNS request. In still a further embodiment of the present invention, DNS Acquisition software component 4061 acts as a DNS proxy and relays a DNS request to a DNS located on WAN 105.

IV. Usage Scenarios

A. PDA Synchronizes Against The Corporate Exchange Server

In this scenario, a user is a traveling professional who has a PDA and needs to synchronize it against a corporate exchange server while on the road. This synchronization needs to be done securely as the only way to enter the corporate network is via a certified and Information Technology (“IT”) manager approved VPN.

The user also has a cellular telephone having a microrouter 404 and VPN client 406j, which the IT manager installed. The IT manager used the remote management capabilities of the cellular telephone in order to configure a VPN to connect to the corporate network, as well as configured the firewall to block Internet access while the VPN is in use. The user is totally unaware of the VPN and its configurations.

As the user turns on the PDA, which is a Bluetooth™ equipped PDA with a LAN Access profile implementation, the PDA connects to the cellular telephone via the BAP 551 utilizing Bluetooth™. The PDA receives a private IP address.

The user loads the PDA synchronization software, which is configured to synchronize against the corporate exchange server. When hitting the “Synchronize” button, the PDA opens a TCP connection to the IP address of the corporate network.

The IP packets travel across the Bluetooth™ air interface to the cellular telephone using a PPP protocol and PPP 552. When reaching the cellular telephone, the packets go through NAT 553 and the private IP address is translated to a public IP address. The public IP address goes to VPN 406f, which identifies the destination as the corporate LAN. VPN 406f packages the packet over an Internet tunnel, encrypts and signs it. The packet is then sent through the cellular air interface and the Internet, reaching the corporate VPN and exchange servers. The PDA is totally unaware of this process.

B. PDA Synchronizes Against a Notebook on the Short Distance Wireless Network

In this scenario, the user, as described above, needs to synchronize the PDA with a notebook computer.

The notebook has a Bluetooth™ card with a LAN access profile. Once the notebook is turned on, it connects to the user's cellular telephone having microrouter 404 and receives a private IP address.

The user runs the same synchronization software on his PDA, only this time chooses to synchronize with the notebook.

When hitting the “Synchronize” button on the PDA, the PDA opens a TCP connection to the notebook's IP address.

An IP packet travels, from the PDA, through the Bluetooth™ interface over a PPP protocol and reaches routing 550 in microrouter 404 that identifies the packet destined to a private IP address of the notebook. The IP packet is then sent to the notebook through the notebook's Bluetooth™ interface over a PPP protocol.

C. Web Pad Browsing the Internet

In this scenario, a user has a Web Pad equipped with a Bluetooth™ interface with a LAN access profile. The Web Pad is connected to the cellular telephone having microrouter 404, which is in the user's bag, and receives a private IP address through the LAN access profile. The Web Pad also has a web browser.

The user pulls out his Web Pad, goes to a URL line of the browser and types http://www.iximobile.com. The web browser first has to translate the name www.iximobile.com into a public IP address. This is done using a DNS. The Web Pad already received the private IP address of a DNS Acquisition software component 4061 when it connected to the cellular telephone. The Web Pad sends a resolve request to the DNS Acquisition software component 4061 in microrouter 404. DNS Acquisition software component 4061 looks at its cache for the name. If the name is not available, the DNS Acquisition software component 4061 obtains DNS address 101b on a WAN 105 to get the public IP address of the name. In both cases, the DNS eventually gets the public IP address for www.iximobile.com and sends the reply back to the Web Pad When the Web Pad receives the public IP address of the web site, it opens a TCP connection at port 80 of that public IP address in order to implement the HTTP protocol and get the HTML page to display.

V. Manager Server

In an embodiment of the present invention, Manager server 102, illustrated in FIG. 1, includes Manager software component 700 illustrated in FIG. 7a. In an embodiment of the present invention, Manager software component 700 is used to load microrouter 404 and plug-ins 406 into device 106. In an additional embodiment of the present invention, Manager software 700 is used to manage, configure and collect data from short distance wireless network 116. In still another embodiment of the present invention, manager software 700 is not used with short distance wireless network 116.

Manager server 102 includes a Proliant server available from Compaq® Computer Corporation of Houston, Tex. having a Windows® 2000 operating system available from Microsoft® Corporation in an embodiment of the present invention.

In an embodiment of the present invention, Manager software component 700 has an IP interface in order to gain access to microrouter 404 and access a device notification service, such as SMS 406h. Manager 700 can be installed on any network that has IP connectivity to microrouter 404. Manager 700 can be installed by a service provider on Internet 103, or by an operator 115 on its IP backend network having server 102.

Manager software component 700 includes two software components, Network Manager software 701 and Extended Network Manager software 702, in an embodiment of the present invention.

Network Manager software 701 is responsible for, but not limited to, the following functions: 1) configuring an IP parameter, such as IP domain range or policies, 2) configuring plug-ins 406 currently installed and executed, 3) enabling/disabling an installed plug-ins 406, 4) loading new plug-ins in microrouter 404, and 5) removing plug-ins 406 from microrouter 404.

Network Extended Manager software 702 is responsible for, but not limited to, the following functions: 1) collecting usage profiles for each microrouter 404 and each terminal in short distance wireless network 116, 2) managing PINs, such as denying access to short distance wireless network 116 for a particular terminal or approving access to short distance wireless network 116 for other terminals, 3) managing security, such as configuring VPN 406b or configuring Firewall 406c, 4) configuring Link Optimization 406e, and 5) configuring Quality of Service (“QoS”) parameters in microrouter 404.

In an embodiment of the present invention, Plug-In Manager software components 706a-f are stored in manager server 102 and use network manager software component 701 and/or Extended Network Manager software component 702 for accessing and controlling network plug-ins 406a-1. For example, a Plug-In Manager software component 706d is used to obtain statistics information from Statistics plug-in 406d in microrouter 404. In an embodiment of the present invention, there is a corresponding plug-in Manager software component in manager software 700 for every plug-in software component in microrouter 404.

VI. DNS Server

FIG. 7b illustrates DNS server 101a shown in FIG. 1 in an embodiment of the present invention. DNS server 101a stores and executes instructions of DNS software component 801 that provides a DNS to WAN 105. In an embodiment of the present invention, a DNS software component 801 includes table 801a having a list of host names or IP domains and IP addresses used in translation. In an embodiment of the present invention, device 106 uses DNS address 101b provided by server 101 to locate and obtain a DNS provided by DNS server 101a for device 106 and terminals 107.

VII. Conclusion

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1) A device in a short distance wireless network, comprising:
a processor; and,
a memory, coupled to the processor, capable to store a software component for selectively obtaining a cellular network attribute.

2) The device of claim 1, wherein the cellular network attribute includes a domain naming service (“DNS”) address.

3) The device of claim 1, wherein the cellular network attribute includes a private Internet Protocol (“IP”) address for the first terminal.

4) The device of claim 1, wherein the communicating includes the first terminal establishing a short-range LAN access profile session with the device.

5) The device of claim 1, wherein the software component establishes a cellular data service session responsive to a comparison of a current public IP address and current access point name (“APN”) and a previous public IP address and a previous APN, and wherein the software component obtains a domain naming service (“DNS”) address using the cellular data service session.

6) The device of claim 1, wherein the software component establishes a cellular data service session, and wherein the software component obtains a domain naming service (“DNS”) address using the cellular data service session.

7) The device of claim 1, wherein the software component establishes a cellular data service session and obtains a domain naming service (“DNS”) address in the cellular network responsive to a threshold time value.

8) The device of claim 1, wherein the software provides a first domain naming service (“DNS”) address, stored in the device, to the first terminal and obtains a second DNS address in the cellular network using a cellular data service session and provides the second DNS address to the first terminal.

9) The device of claim 1, wherein the software provides a previous domain naming service (“DNS”) address to the first terminal and terminates a connection with the first terminal responsive to a comparison of the previous DNS and a current DNS address obtained from the cellular network using a cellular data service session.

10) The device of claim 1, wherein the network attribute is obtained using a general packet radio service (“GPRS”) in a Global System for Mobile communications (“GSM”) cellular network.

11) The device of claim 1, wherein the short distance wireless network is a Bluetooth™ wireless local area network.

12) The device of claim 1, wherein the short distance wireless network is an 802.11 wireless local area network.

13) The device of claim 1, wherein the device further includes a short-range LAN Access profile software component.

14) The device of claim 1, wherein the device is a cellular telephone.

15) A method, comprising the steps of:
generating a first short-range radio message requesting a domain naming service (“DNS”) address by a terminal in a short distance wireless network;
receiving by a device in the short-range radio message;
generating a cellular signal, by the device, to obtain a cellular data service in a cellular network;
obtaining, by the device, a domain naming service (“DNS”) address in the cellular network; and
generating a second short-range radio message, by the device to the terminal, including the DNS address.

16) A method, comprising the steps of:
comparing a current IP address and current access point name (“APN”) to a previous IP address and a previous APN;
generating a cellular signal, by the device, to obtain a cellular data service in a cellular network responsive to the comparing;
obtaining, by the device, a domain naming service (“DNS”) address in the cellular network; and
generating a second short-range radio message, by the device to a terminal, including the DNS address.

17) A method, comprising the steps of:
measuring an amount of time since a device established a cellular data service session;
comparing the measured amount of time to a threshold value.
generating a cellular signal, by the device in the short distance wireless network, to obtain a cellular data service in a cellular network responsive to the comparing;
obtaining, by the device, a domain naming service (“DNS”) address in the cellular network; and,
generating a short-range radio message, by the device to a terminal, including the DNS address.

18) A method, comprising the steps of:
generating a first short-range radio message requesting a domain naming service (“DNS”) address by a terminal in a short distance wireless network;
receiving, by a device in the short distance wireless network, the first short-range radio message;
obtaining a first DNS address stored in the device;
generating a second short-range radio message including the DNS address, by the device to the terminal;
generating a cellular signal, by the device, to obtain a cellular data service in a cellular network;
obtaining, by the device, a second DNS address in the cellular network; and
generating a third short-range radio message, by the device to the terminal, including the second DNS address.

19) A method, comprising the steps of:
generating, by a terminal in a short distance wireless network, a first short-range radio message requesting a domain naming service (“DNS”) address;
receiving, by a device in the short distance wireless network, the first short-range radio message;
obtaining a first DNS address stored in a device;
generating a second short-range radio message including the first DNS address, by the device to the terminal;
generating a cellular signal, by the device, to obtain a cellular data service in a cellular network;
obtaining, by the device, a second domain naming service (“DNS”) address in the cellular network;
comparing the first DNS and the second DNS;
terminating communication between the terminal and the device responsive the comparing step;
establishing a communication between the terminal and the device; and,
generating, by the device, a third short-range radio message including the second DNS address to the terminal

20) The method of claim 19, wherein the device is a cellular telephone.

21) The method of claim 19, wherein the cellular network is a Global System for Mobile communications (“GSM”) cellular network and the cellular data service is a general packet radio service (“GPRS”).

22) The method of claim 19, wherein the short distance wireless network is a Bluetooth™ wireless local area network.

23) The method of claim 19, wherein the short distance wireless network is an 802.11 wireless local area network.

24) A system for providing communication between a cellular network and a short distance wireless network, comprising:
a hand-held wireless device, including:
a cellular transceiver capable to communicate with the cellular network, including to receive a domain naming service (“DNS”) address from a cellular data service;
a short-range transceiver capable to communicate with the short distance wireless network, including to receive a first short-range radio message and to generate a second short-range radio message including the DNS address;
a memory, coupled to the cellular and short-range transceivers, capable to store a software component to obtain the DNS address; and,
a first wireless device capable to generate the first short-range radio message and to receive the second short-range radio message.

25) A system for providing communication between a cellular network and a short distance wireless network, comprising:
a hand-held wireless device, including:
a cellular transceiver capable to communicate with the cellular network, including to receive a domain naming service (“DNS”) address from a cellular data service;
a short-range transceiver capable to communicate with the short distance wireless network, including to generate a first short-range radio message including the DNS address;
a memory, coupled to the cellular and short-range transceivers, capable to store a software component to obtain the DNS address responsive to a comparison of a current cellular network address and current access point name (“APN”) and a previous cellular network address and a previous APN; and,
a first wireless device to receive the first short-range radio message.

26) A system for providing communication between a cellular network and a short distance wireless network, comprising:
a hand-held wireless device, including:
a cellular transceiver to communicate with the cellular network, including to receive a domain naming service (“DNS”) address from a cellular data service;
a short-range transceiver to communicate with the short distance wireless network, including to generate a short-range radio message including the DNS address;
a memory, coupled to the cellular and short-range transceivers, capable to store a software component to establish a cellular data service session and obtaining the DNS address in the cellular network responsive to a threshold time value; and,
a first wireless device to receive the first short-range radio message.

27) A system for providing communication between a cellular network and a short distance wireless network, comprising:
a first wireless device to generate a first short-range radio message including a a first domain naming service (“DNS”) request and to receive a second short-range radio message including an IP address responsive to the DNS request; and,
a hand-held wireless device, including:
a cellular transceiver to communicate with the cellular network, including to receive a DNS address from a cellular data service;
a short-range transceiver to communicate with the short distance wireless network, including to receive the first short-range radio message and to generate the second short-range radio message;
a memory, coupled to the cellular and short-range transceivers, capable to store a software component to relay the DNS request to the DNS address using a cellular data service session.

28) A system for providing communication between a cellular network and a short distance wireless network, comprising:
a first wireless device capable to receive a first and a second short-range radio message; and,
a hand-held wireless device, including:
a cellular transceiver to communicate with the cellular network, including to receive a first and a second domain naming service (“DNS”) address from a cellular data service;
a short-range transceiver to communicate with the short-range radio network, including to generate the first and the second short-range radio messages including the first and the second DNS addresses, respectively;
a memory, coupled to the cellular and short-range transceivers, capable to store a software component to provide a first DNS address to the first wireless device and terminate communication with the first wireless device responsive to a comparison of the first DNS and the second DNS addresses obtained from the cellular network using a cellular data service session.

29) The system of claim 28, wherein the first wireless device is selected from a group consisting of a desktop computer, a laptop computer, a personal digital assistant, a headset, a pager, a pen, a printer, a watch, a digital camera and an equivalent.

30) An article of manufacture, including a computer readable medium, comprising:
a short-range radio software component to receive a first short-range radio signal in a short distance wireless network;
a cellular software component to provide a communication signal in a cellular network; and,
a software component to obtain a domain naming service (“DNS”) address in a cellular network responsive to receiving the first short-range radio signal, wherein the short-range radio software component generates a second short range radio signal including the DNS address.
